(19) United States
(12) Patent Application Publication
(10) Pub. No.: US 2015/0378957 A1
(43) Pub. Date: Dec. 31, 2015

(54) EMPLOYING MULTIPLE I2C DEVICES BEHIND A MICROCONTROLLER IN A DETACHABLE PLATFORM

(71) Applicant: Intel Corporation, Santa Clara, CA (US)

(72) Inventors: NICHOLAS J. ADAMS, Beaverton, OR (US); BASAVARAJ B. ASTEKAR, Hillsboro, OR (US)

(73) Assignee: Intel Corporation, Santa Clara, CA (US)

(21) Appl. No.: 14/318,461

(22) Filed: Jun. 27, 2014

(51) Int. Cl. G06F 13/42; G06F 13/10; G06F 9/54; G06F 13/40

(52) U.S. Cl. CPC G06F 13/4282; G06F 13/4072; G06F 13/102; G06F 13/404; G06F 9/546

(57) ABSTRACT

Methods and apparatus relating to employing multiple I2C (Interface to Communicate) devices behind a microcontroller in a detachable platform are described. In an embodiment, first logic receives a first message via a serial single ended (such as an Interface to Communicate (I2C)) bus. The first logic generates a second message to be transmitted to second logic in response to a determination that the first message is not directed to an address space assigned to the first logic. The second message includes information from the first message. Other embodiments are also disclosed.

### FIELD

The present disclosure generally relates to the field of electronics. More particularly, an embodiment relates to employing multiple I2C (Interface to Communicate) devices behind a microcontroller in a detachable platform.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of an embodiment of a computing systems, which can be utilized to implement various embodiments discussed herein.

FIG. 2 illustrates a block diagram of an embodiment of a computing system, which can be utilized to implement one or more embodiments discussed herein.

FIG. 3 illustrates a block diagram of components of a detachable computing system, in accordance with an embodiment.

FIG. 4 illustrates a flow diagram of a method to employ multiple I2C devices behind a microcontroller in a detachable platform, in accordance with an embodiment.

FIG. 5 illustrates a block diagram of an embodiment of a computing system, which can be utilized to implement one or more embodiments discussed herein.

FIG. 6 illustrates a block diagram of an embodiment of a computing system, which can be utilized to implement one or more embodiments discussed herein.

FIG. 7 illustrates a block diagram of an System On Chip (SOC) package in accordance with an embodiment.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments. Various aspects of embodiments may be performed using various means, such as integrated semiconductor circuits (“hardware”), computer-readable instructions organized into one or more programs (“software”) or some combination of hardware and software. For the purposes of this disclosure reference to “logic” shall mean either hardware, software, or some combination thereof.

I2C (or Interface to Communicate) provides a relatively low-cost solution to couple low-speed peripherals to a computing device. I2C generally refers to a master based (or multi-master based) serial single ended computer bus/interface used for attaching low-speed peripherals, e.g., to a motherboard, embedded system, cell phone, or other electronic device such as mobile computing devices or other computing devices discussed herein). With the changing form factors of the Personal Computers (PCs) in the current environment, there is a significant push to provide platforms that are detachable, for example, so that a tablet computer can be attached to a computing base to extend the capability of the tablet computer. However, as more devices are added to the base of such computers, certain technical difficulties can be exposed. One such difficulty is the ability to integrate several I2C devices behind a secondary Embedded Controller (EC). While such a configuration can be designed at the hardware and signal level, it poses significant issues with the software infrastructure that is currently provided in the industry. These issues include changes required for I2C device drivers, the Advanced Configuration and Power Interface (ACPI) BIOS (Basic Input Output System) implementation (e.g., in accordance with ACPI Specification, Revision 5.0a, Nov. 13, 2013), and the Operating System (OS). Moreover, when these items have already been shipped to customers, making such infrastructure changes within them becomes even more difficult and costly.

To this end, some embodiments employ multiple I2C devices behind a microcontroller (or EC) in a detachable platform. An embodiment utilizes changes to the underlying logic (e.g., hardware and/or firmware) infrastructure in order to hide the abstraction of the additional device(s) in the computing base device from entities that run within the OS scope.

Such embodiments may significantly increase the available options (e.g., for an OEM (Original Equipment Manufacturer)) in choosing devices to add to a computing base device, e.g., without requiring changes to device drivers and/or the Operating Systems. As such, these techniques provide more options for detachable configuration, while reducing the cost of such implementations, for example, by moving to devices that are more readily available and coupled via cheaper buses or interconnects (such as I2C).

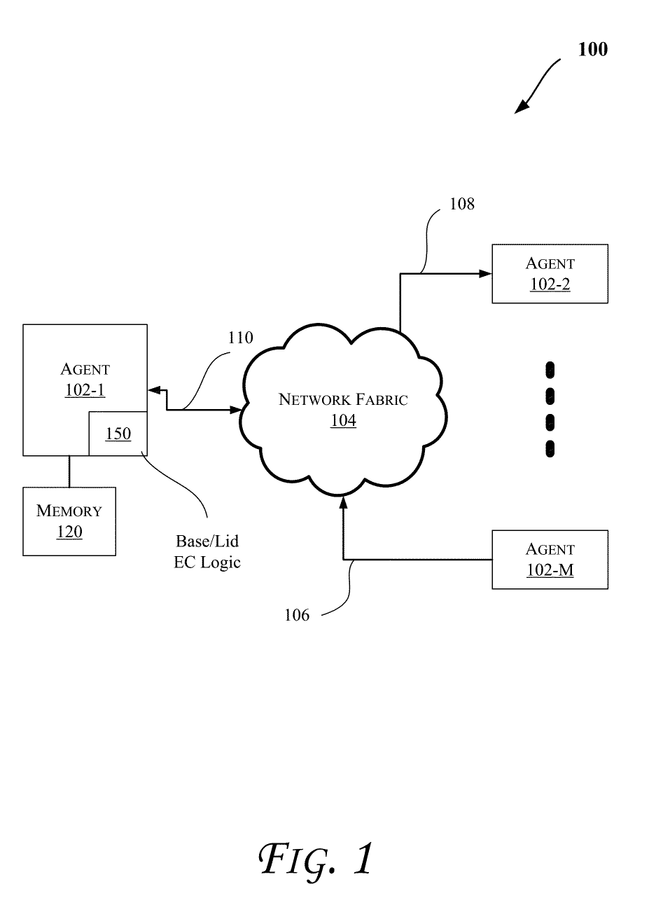

Moreover, the techniques discussed herein can be utilized in various computing systems (e.g., including a mobile device such as a smartphone, tablet, UMPC (Ultra-Mobile Personal Computer), laptop computer, Ultrabook™ computing device, smart watch, smart glasses, etc.), such as those discussed with reference to FIGS. 1-7. More particularly, FIG. 1 illustrates a block diagram of a computing system 100, according to an embodiment. The system 100 includes one or more agents 102-1 through 102-M (collectively referred to herein as “agents 102” or more generally “agent 102”). In an embodiment, one or more of the agents 102 are components of a computing system, such as the computing systems discussed with reference to FIGS. 1-7.

As illustrated in FIG. 1, the agents 102 communicate via a network fabric 104. In one embodiment, the network fabric 104 includes a computer network that allows various agents (such as computing devices) to communicate data. In an embodiment, the network fabric 104 includes one or more interconnects (or interconnection networks) that communicate via a serial (e.g., point-to-point) link and/or a shared communication network (which is be configured as a ring in an embodiment). Each link may include one or more lanes. For example, some embodiments facilitate component debug or validation on links that allow communication with Fully Buffered Dual in-line memory modules (FBD), e.g., where the FBD link is a serial link for coupling memory modules to a host controller device (such as a processor or memory hub). Debug information is transmitted from the FBD channel host such that the debug information is observed along the channel by channel traffic trace capture tools (such as one or more logic analyzers).

In one embodiment, the system 100 supports a layered protocol scheme, which includes a physical layer, a link layer, a routing layer, a transport layer, and/or a protocol layer. The fabric 104 further facilitates transmission of data (e.g., in form of packets) from one protocol (e.g., caching processor or caching aware memory controller) to another protocol for a point-to-point or shared network. Also, in some embodiments, the network fabric 104 provides communication that adheres to one or more cache coherent protocols.

Furthermore, as shown by the direction of arrows in FIG. 1, the agents 102 can transmit and/or receive data via the network fabric 104. Hence, some agents utilize a unidirectional link, while others utilize a bidirectional link for communication. For instance, one or more agents (such as agent 102-M) transmit data (e.g., via a unidirectional link 106), other agent(s) (such as agent 102-2) receive data (e.g., via a unidirectional link 108), while some agent(s) (such as agent 102-1) both transmit and receive data (e.g., via a bidirectional link 110).

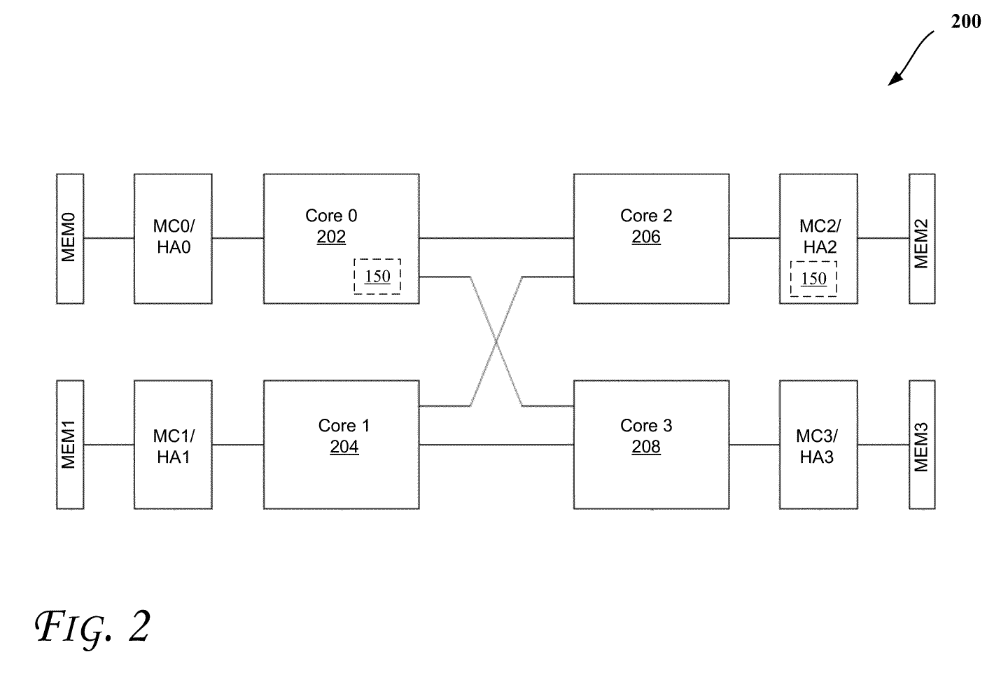

Additionally, at least one of the agents 102 is a home agent and one or more of the agents 102 are requesting or caching agents. Generally, requesting/caching agents send request(s) to a home node/agent for access to a memory address with which a corresponding “home agent” is associated. Further, in an embodiment, one or more of the agents 102 (only one shown for agent 102-1) have access to a memory (which can be dedicated to the agent or shared with other agents) such as memory 120. In some embodiments, each (or at least one) of the agents 102 is coupled to the memory 120 that is either on the same die as the agent or otherwise accessible by the agent. Also, as shown in FIG. 1, agents 102 include I2C EC logic 150 to facilitate communication of I2C message between components of the agent 102 or more generally components of system 100, as will be further discussed herein, e.g., with reference to FIGS. 2-7.

FIG. 2 is a block diagram of a computing system 200 in accordance with an embodiment. System 200 includes a plurality of sockets 202-208 (four shown but some embodiments can have more or less socket). Each socket includes a processor. Also, various agents in the system 200 can communicate via logic 150. Even though logic 150 is only shown in items 202 and MC2/HA2, logic 150 may be provided in other agents of system 200. Further, more or less logic blocks can be present in a system depending on the implementation. Additionally, each socket is coupled to the other sockets via a point-to-point (PtP) link, or a differential interconnect, such as a Quick Path Interconnect (QPI), MIPI (Mobile Industry Processor Interface), etc. As discussed with respect the network fabric 104 of FIG. 1, each socket is coupled to a local portion of system memory, e.g., formed by a plurality of Dual Inline Memory Modules (DIMMs) that include dynamic random access memory (DRAM).

In another embodiment, the network fabric is utilized for any System on Chip (SoC or SOC) application, utilize custom or standard interfaces, such as, ARM compliant interfaces for AMBA (Advanced Microcontroller Bus Architecture), OCP (Open Core Protocol), MIPI (Mobile Industry Processor Interface), PCI (Peripheral Component Interconnect) or PCIe (Peripheral Component Interconnect express).

Some embodiments use a technique that enables use of heterogeneous resources, such as AXI/OCP technologies, in a PC (Personal Computer) based system such as a PCI-based system without making any changes to the IP resources themselves. Embodiments provide two very thin hardware blocks, referred to herein as a Yunit and a shim, that can be used to plug AXI/OCP IP into an auto-generated interconnect fabric to create PCI-compatible systems. In one embodiment, a first (e.g., a north) interface of the Yunit connects to an adapter block that interfaces to a PCI-compatible bus such as a direct media interface (DMI) bus, a PCI bus, or a Peripheral Component Interconnect Express (PCIe) bus. A second (e.g., south) interface connects directly to a non-PC interconnect, such as an AXI/OCP interconnect. In various implementations, this bus may be an OCP bus.

In some embodiments, the Yunit implements PCI enumeration by translating PCI configuration cycles into transactions that the target IP can understand. This unit also performs address translation from re-locatable PCI addresses into fixed AXI/OCP addresses and vice versa. The Yunit may further implement an ordering mechanism to satisfy a producer-consumer model (e.g., a PCI producer-consumer model). In turn, individual IPs are connected to the interconnect via dedicated PCI shims. Each shim may implement the entire PCI header for the corresponding IP. The Yunit routes all accesses to the PCI header and the device memory space to the shim. The shim consumes all header read/write transactions and passes on other transactions to the IP. In some embodiments, the shim also implements all power management related features for the IP.

Thus, rather than being a monolithic compatibility block, embodiments that implement a Yunit take a distributed approach. Functionality that is common across all IPs, e.g., address translation and ordering, is implemented in the Yunit, while IP-specific functionality such as power management, error handling, and so forth, is implemented in the shims that are tailored to that IP.

In this way, a new IP can be added with minimal changes to the Yunit. For example, in one implementation the changes may occur by adding a new entry in an address redirection table. While the shims are IP-specific, in some implementations a large amount of the functionality (e.g., more than 90%) is common across all IPs. This enables a rapid reconfiguration of an existing shim for a new IP. Some embodiments thus also enable use of auto-generated interconnect fabrics without modification. In a point-to-point bus architecture, designing interconnect fabrics can be a challenging task. The Yunit approach described above leverages an industry ecosystem into a PCI system with minimal effort and without requiring any modifications to industry-standard tools.

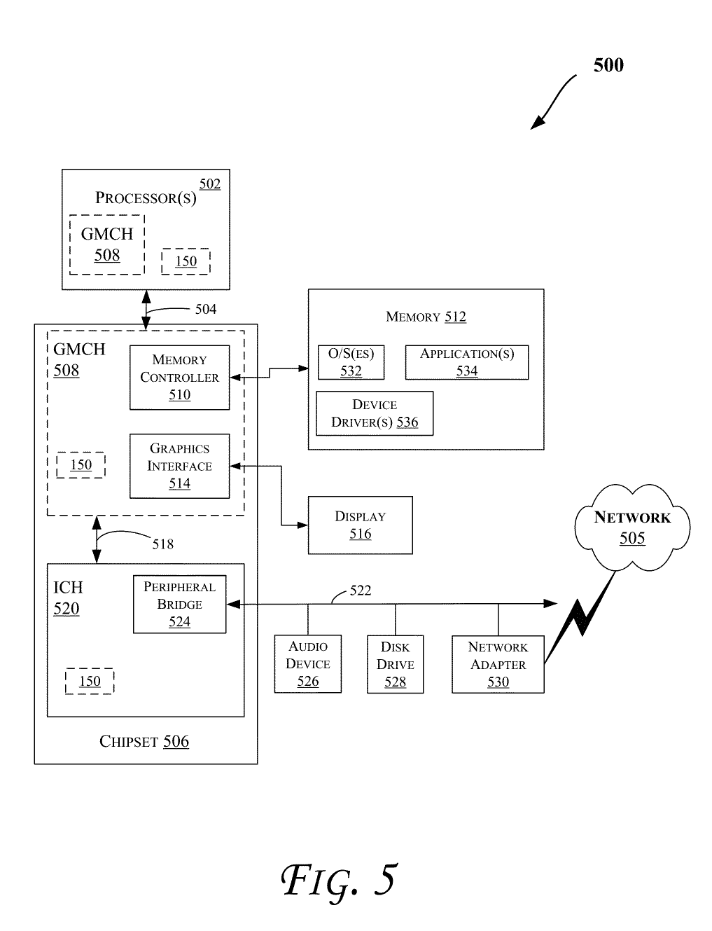

As shown in FIG. 2, each socket is coupled to a Memory Controller (MC)/Home Agent (HA) (such as MC0/HA0 through MC3/HA3). The memory controllers are coupled to a corresponding local memory (labeled as MEM0 through MEM3), which can be a portion of system memory (such as memory 512 of FIG. 5). In some embodiments, the memory controller (MC)/Home Agent (HA) (such as MC0/HA0 through MC3/HA3) can be the same or similar to agent 102-1 of FIG. 1 and the memory, labeled as MEM0 through MEM3, can be the same or similar to memory devices discussed with reference to any of the figures herein. Also, in one embodiment, MEM0 through MEM3 can be configured to mirror data, e.g., as master and slave. Also, one or more components of system 200 can be included on the same integrated circuit die in some embodiments.

Furthermore, at least one implementation (such as shown in FIG. 2) can be used for a socket glueless configuration with mirroring. For example, data assigned to a memory controller (such as MC0/HA0) is mirrored to another memory controller (such as MC3/HA3) over the PtP links.

In some current implementations, Embedded Controllers (ECs) can be a host to an I2C device and/or a slave on an I2C bus. In detachable platforms, there can be a secondary EC in the base of a platform that is used as both a slave to the primary lid EC device (such as a lid EC in a tablet computer) and as a host for device(s) on the base, which are coupled to it via I2C. This level of abstraction creates problems for the OS as the OS would load drivers directly for the I2C devices that are coupled to the primary EC, but under the current architecture these devices coupled through an additional EC are hidden from the OS.

In order to address this problem without needing changes to the OS or OS-level device drivers, changes can be made to the EC which allow it to claim multiple slave addresses on the I2C bus. This requires changes to both the hardware implementation of the I2C slave device on the EC as well as the EC firmware/logic. Once the EC is able to claim multiple addresses on the bus, e.g., based on a firmware controlled definition, it can provide a mechanism to expose these devices to the OS without any need to change the OS infrastructure and/or device drivers.

Furthermore, an embodiment can be used in the context of I2C in combination with a fixed software definition to solve real-world platform enabling problems. Moreover, the above-discussed issues generally result from the need to be able to dynamically add and remove devices from a system during runtime (though this type of device was not originally designed for that behavior), while at the same time not altering the software infrastructure widely available within the industry.

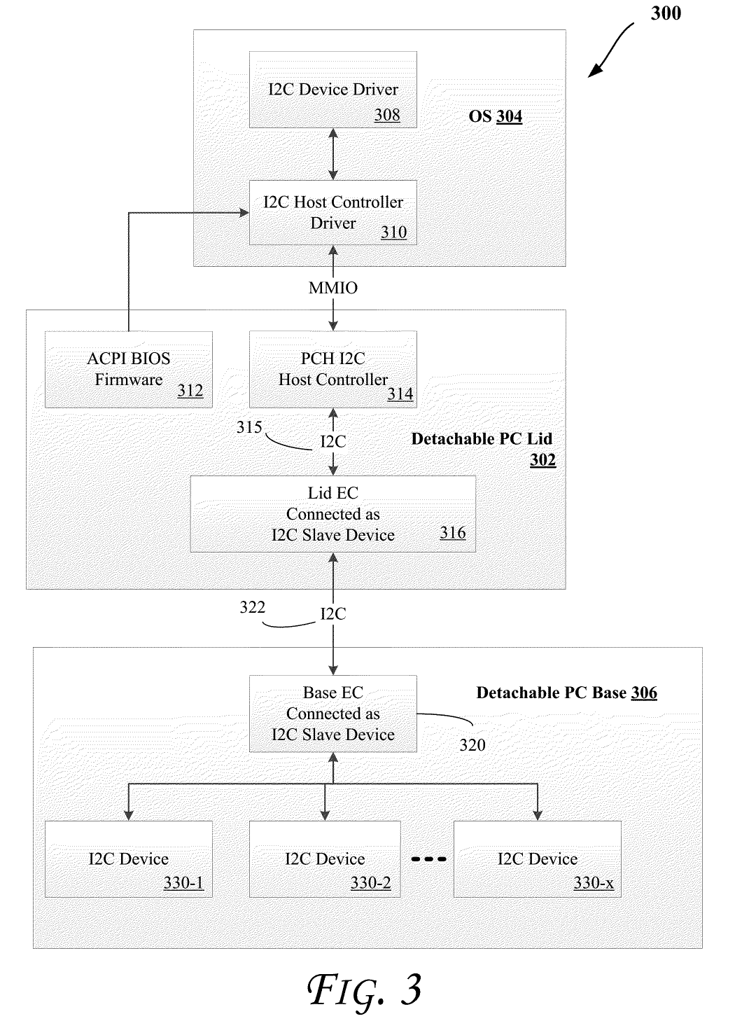

FIG. 3 illustrates a block diagram of components of a detachable computing system 300, in accordance with an embodiment. As shown in FIG. 3, system 300 includes a detachable PC lid portion 302 (coupled to OS 304) and a detachable PC base portion 306. Lid portion 302 includes various components such as a display device (including, for example, a flat-panel display device such as a liquid crystal display device, light emitting diode display device, Active Matrix Organic Light Emitting Diode display device, etc.), one or more buttons (e.g., to interact with the OS/application(s)), one or more sensors (e.g., to detect variations in temperature, location (such as a gyroscopic sensor, global positioning system (GPS) sensor, etc.), time, ambient light, etc.), one or more processors, one or more batteries, image capture device, etc. such as discussed with reference to FIGS. 5-7).

OS 304 includes an I2C device driver 308 that communicates with the detachable PC lid 302 via an I2C host controller driver 310. Detachable PC lid 302 includes an ACPI BIOS firmware 312 and PCH I2C host controller 314 that communicate with the I2C host controller driver 310. In an embodiment, a MMIO (Memory Mapped Input/Output) may be used for communication between the I2C host controller driver 310 and the PCH I2C host controller 314. PCH I2C host controller 314 may use an I2C 315 to communicate with lid EC 316 (e.g., connected as an I2C slave device).

As illustrated in FIG. 3, detachable PC lid 302 is coupled to the detachable PC base 306 via lid EC 316 that is coupled to a base EC 320 (e.g., connected as an I2C slave device) via an I2C 322. The base EC 320 is in turn coupled to one or more I2C devices (330-1 to 330-x, collectively referenced herein as I2C devices “330”), which may include a battery, keyboard, sensors, other computing device components (such as those discussed with reference to FIGS. 5-7), etc.

In an embodiment, one or more I2C devices 330 are added on the base via the EC connections of base EC 320. Moreover, under some current I2C ACPI definitions, every device is required to have its own I2C slave address. This is an assumption that is built into the OS 304 and I2C host controller driver 310. However, the only slave device that is directly accessible to the OS 306 from the device driver 308 is the one that is coupled to the lid EC 316 and is directly coupled to the PCH I2C host controller 314. Addresses of the other I2C devices 330 are not addressable directly by the OS 306. Additionally, other I2C devices could be added to the detachable PC lid 302 via lid EC 316 (not shown), which would otherwise not be directly accessible form the OS without the embodiments discussed herein).

In some embodiments, the implementation of the slave I2C device on each of the ECs (316 and/or 320) are changed to be able to programmatically claim multiple I2C slave addresses even though it is technically/physically only a single connection and device. Each EC can then either claim an incoming message for itself and process it or pass the message on to the child I2C connection that it is hosting with the same slave address. While this introduces some amount of latency, the latency should be relatively limited.

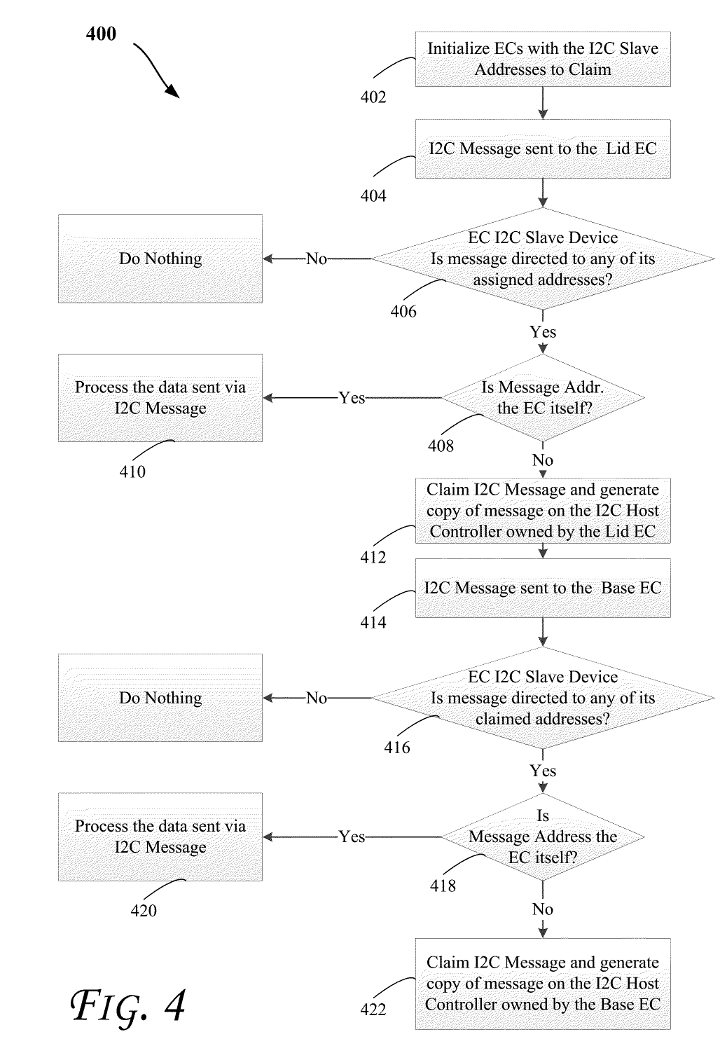

FIG. 4 illustrates a flow diagram of a method 400 to employ multiple I2C devices behind a microcontroller or EC in a detachable platform, in accordance with an embodiment. In one embodiment, various components discussed with reference to FIGS. 1-3 and 5-7 can be utilized to perform one or more of the operations discussed with reference to FIG. 4. In an embodiment, method 400 is implemented in logic (e.g., firmware) such as logic 150 of FIG. 1 (which includes one or more EC such as ECs 316 and/or 320 of FIG. 3, for example).

Referring to FIGS. 1-4, at an operation 402, one or more ECs (e.g., ECs 316 and/or 320) are initialized with I2C slave addresses to claim/assign for each EC. At an operation 404, an I2C message is sent to the lid EC 316. At an operation 406, it is determined by the lid EC 316 whether the received message is directed to any of EC 316's assigned/claimed addresses. If not, no further action needs to be taken for the received message; otherwise, an operation 408 determines whether the received message is addressed to the EC 316 itself. If it is, then the EC 316 processes the data sent via an I2C message at operation 410. If the message is not addressed to the EC 316 at operation 408, EC 316 claims the message at operation 412 and generates a corresponding message (e.g., a copy of the originally received message) on I2C 322 directed at based EC 320 at operation 414. In an embodiment, the generated message is provided on an I2C host controller owned by the lid EC 316 (not shown).

At operation 416, it is determined by the base EC 320 whether the received message is directed to any of EC 320's assigned/claimed addresses. If not, no further action needs to be taken for the message; otherwise, an operation 418 determines whether the received message is addressed to the EC 320 itself. If it is, then the EC 320 processes the data sent via an I2C message at operation 420. If the message is not addressed to the EC 320 at operation 418, EC 320 claims the message at operation 422 and generates a corresponding message (e.g., a copy of the originally received message) on an I2C host controller owned by the base EC 320 (not shown).

Accordingly, some embodiments employ multiple I2C devices behind a microcontroller/EC in a detachable platform without changes to the OS device drivers or the OS. One reason that this approach does not require changes to the OS or OS-level drivers is because of the mechanism that is used to perform the driver loading. Current implementations require the platform BIOS to articulate a connection to an I2C device per the definition in the ACPI specification. This definition assumes a device described is coupled to a specific I2C host controller that the OS has direct access to via MMIO. There is no mechanism currently defined which allows for an I2C host controller to be defined as coupled via I2C. This layered implementation of I2C host controllers is not supported by current definitions.

The following pseudo code illustrates a sample ACPI definition of a device on an I2C bus, according to an embodiment.

Scope (\SB.PCI0.I2C0) // Host Controller Scope
{

Device (MyDV)
{

Name (_CRS, ResourceTemplate( )
{

I2CSerialBus ( 0x7f,

ControllerInitiated,
100000,
AddressingMode7Bit,
“\\_SB.PCI0.I2C0”,,, , )

| }) | |
|---|---|
| Method (_STA) | // Status of the I2C coupled device |

{

If (LEqual(DCKD, 0x01)) // If docked, report device
presence
{

Return(0x0f)

} else {

Return(0x00)

}

}

}

}

The_STA method defined above ensures that changes to the docking state of the platform can be used to invoke a notification event to the OS which changes the current state, and thus availability of the I2C coupled device to the OS. Further, changes proposed to the EC allow the implementer to keep a consistent definition at the OS layer with no changes to either the OS or drivers. This in turn allows for a much quicker deployment to the industry as it can be done with the current software infrastructure that is readily available in the market today.

The changes in today's platforms that are made to support this embodiment are both within the EC logic 150. The I2C slave device within the EC includes logic changes such that multiple slave addresses can be claimed, and that those addresses are assigned programmatically (e.g., via firmware/logic). Additionally, firmware/logic considers all messages that are claimed by the I2C slave device within that EC and then process those messages. Hence, the processing will result in either direct processing or passing the message to a child I2C bus.

FIG. 5 illustrates a block diagram of an embodiment of a computing system 500. One or more of the agents 102 of FIG. 1 may comprise one or more components of the computing system 500. Also, various components of the system 500 include logic 150 as illustrated in FIG. 5. However, logic 150 may be provided in locations throughout the system 500, including or excluding those illustrated. The computing system 500 includes one or more central processing unit(s) (CPUs) 502 (collectively referred to herein as “processors 502” or more generically “processor 502”) coupled to an interconnection network (or bus) 504. The operations discussed with reference to FIGS. 1-4 can be performed by one or more components of the system 500.

The processors 502 can be any type of processor such as a general purpose processor, a network processor (which processes data communicated over a computer network 505), etc. (including a reduced instruction set computer (RISC) processor or a complex instruction set computer (CISC)). Moreover, the processors 502 has a single or multiple core design. The processors 502 with a multiple core design integrate different types of processor cores on the same integrated circuit (IC) die. Also, the processors 502 with a multiple core design can be implemented as symmetrical or asymmetrical multiprocessors.

The processor 502 include one or more caches, which are private and/or shared in various embodiments. Generally, a cache stores data corresponding to original data stored elsewhere or computed earlier. To reduce memory access latency, once data is stored in a cache, future use can be made by accessing a cached copy rather than prefetching or recomputing the original data. The cache(s) can be any type of cache, such a level 1 (L1) cache, a level 2 (L2) cache, a level 3 (L3), a mid-level cache, a last level cache (LLC), etc. to store electronic data (e.g., including instructions) that is utilized by one or more components of the system 500. Additionally, such cache(s) can be located in various locations (e.g., inside other components to the computing systems discussed herein, including systems of FIGS. 1, 2, 5, 6, or 7).

A chipset 506 can additionally be coupled to the interconnection network 504. Further, the chipset 506 includes a graphics memory control hub (GMCH) 508. The GMCH 508 includes a memory controller 510 that is coupled to a memory 512. The memory 512 stores data, e.g., including sequences of instructions that are executed by the processor 502, or any other device in communication with components of the computing system 500. Also, in one embodiment, the memory 512 includes one or more volatile storage (or memory) devices such as random access memory (RAM), dynamic RAM (DRAM), synchronous DRAM (SDRAM), static RAM (SRAM), etc. Nonvolatile memory can also be utilized such as a hard disk. Additional devices can be coupled to the interconnection network 504, such as multiple processors and/or multiple system memories.

The GMCH 508 further includes a graphics interface 514 coupled to a display device 516 (e.g., via a graphics accelerator in an embodiment). In one embodiment, the graphics interface 514 is coupled to the display device 516 via an Accelerated Graphics Port (AGP) or Peripheral Component Interconnect (PCI) (or PCI express (PCIe) interface). In an embodiment, the display device 516 (such as a flat panel display) is coupled to the graphics interface 514 through, for example, a signal converter that translates a digital representation of an image stored in a storage device such as video memory or system memory (e.g., memory 512) into display signals that are interpreted and displayed by the display 516.

As shown in FIG. 5, a hub interface 518 couples the GMCH 508 to an input/output control hub (ICH) 520. The ICH 520 provides an interface to input/output (I/O) devices coupled to the computing system 500. The ICH 520 is coupled to a bus 522 through a peripheral bridge (or controller) 524, such as a Peripheral Component Interconnect (PCI) bridge that is compliant with the PCIe specification, a Universal Serial Bus (USB) controller, I2C, etc. The bridge 524 provides a data path between the processor 502 and peripheral devices. Other types of topologies can also be utilized. Additionally, multiple buses can be coupled to the ICH 520, e.g., through multiple bridges or controllers. Further, bus 522 can comprises other types and configurations of bus systems. Moreover, other peripherals coupled to the ICH 520 include, in various embodiments, integrated drive electronics (IDE) or small computer system interface (SCSI) hard drive(s), USB port(s), I2C device(s), a keyboard, a mouse, parallel port(s), serial port(s), floppy disk drive(s), digital output support (e.g., digital video interface (DVI)), etc.

The bus 522 is coupled to an audio device 526, one or more disk drive(s) 528, and a network adapter 530 (which is a NIC in an embodiment). In one embodiment, the network adapter 530 or other devices coupled to the bus 522 communicate with the chipset 506. Also, various components (such as the network adapter 530) are coupled to the GMCH 508 in some embodiments. In addition, the processor 502 and the GMCH 508 can be combined to form a single chip. In an embodiment, the memory controller 510 is provided in one or more of the CPUs 502. Further, in an embodiment, GMCH 508 and ICH 520 are combined into a Peripheral Control Hub (PCH).

Additionally, the computing system 500 includes volatile and/or nonvolatile memory (or storage). For example, nonvolatile memory includes one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media capable of storing electronic data (e.g., including instructions).

The memory 512 includes one or more of the following in an embodiment: an operating system (O/S) 532, application 534, and/or device driver 536. The memory 512 can also include regions dedicated to Memory Mapped I/O (MMIO) operations. Programs and/or data stored in the memory 512 are swapped into the disk drive 528 as part of memory management operations. The application(s) 534 execute (e.g., on the processor(s) 502) to communicate one or more packets with one or more computing devices coupled to the network 505. In an embodiment, a packet is a sequence of one or more symbols and/or values that are encoded by one or more electrical signals transmitted from at least one sender to at least on receiver (e.g., over a network such as the network 505). For example, each packet has a header that includes various information which is utilized in routing and/or processing the packet, such as a source address, a destination address, packet type, etc. Each packet has a payload that includes the raw data (or content) the packet is transferring between various computing devices over a computer network (such as the network 505).

In an embodiment, the application 534 utilizes the O/S 532 to communicate with various components of the system 500, e.g., through the device driver 536. Hence, the device driver 536 includes network adapter 530 specific commands to provide a communication interface between the O/S 532 and the network adapter 530, or other I/O devices coupled to the system 500, e.g., via the chipset 506.

In an embodiment, the O/S 532 includes a network protocol stack. A protocol stack generally refers to a set of procedures or programs that is executed to process packets sent over a network 505, where the packets conform to a specified protocol. For example, TCP/IP (Transport Control Protocol/Internet Protocol) packets are processed using a TCP/IP stack. The device driver 536 indicates the buffers in the memory 512 that are to be processed, e.g., via the protocol stack.

The network 505 can include any type of computer network. The network adapter 530 can further include a direct memory access (DMA) engine, which writes packets to buffers (e.g., stored in the memory 512) assigned to available descriptors (e.g., stored in the memory 512) to transmit and/or receive data over the network 505. Additionally, the network adapter 530 includes a network adapter controller logic (such as one or more programmable processors) to perform adapter related operations. In an embodiment, the adapter controller is a MAC (media access control) component. The network adapter 530 further includes a memory, such as any type of volatile/nonvolatile memory (e.g., including one or more cache(s) and/or other memory types discussed with reference to memory 512).

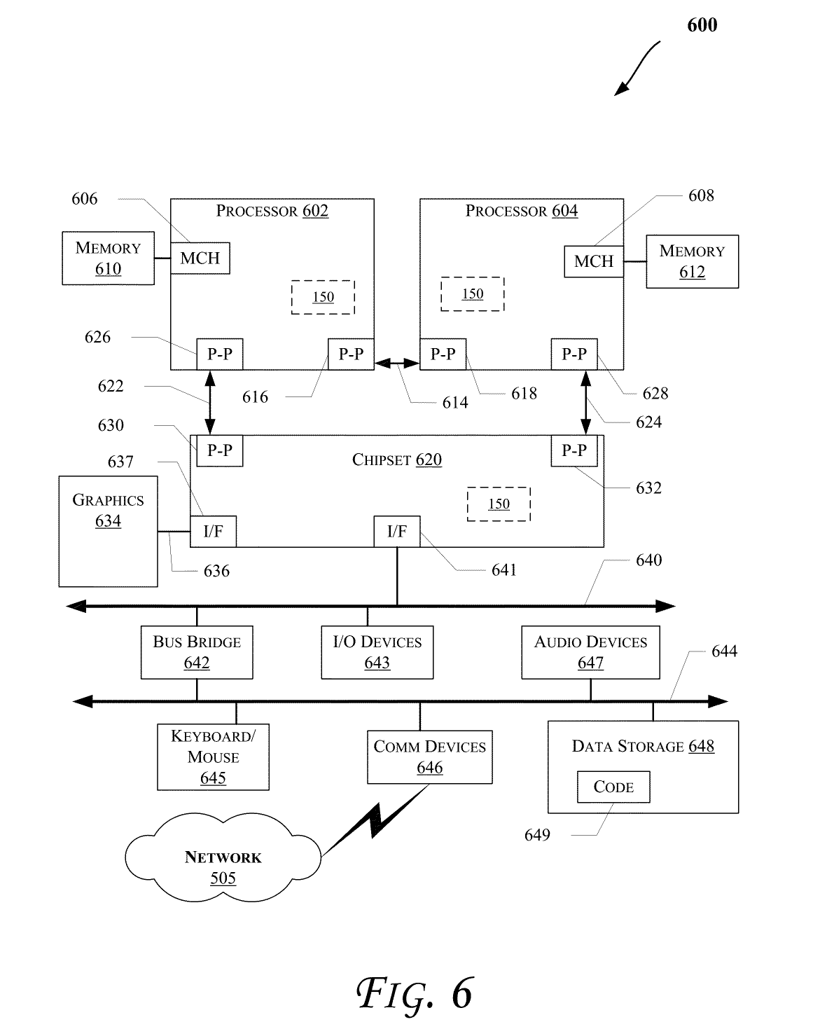

FIG. 6 illustrates a computing system 600 that is arranged in a point-to-point (PtP) configuration, according to an embodiment. In particular, FIG. 6 shows a system where processors, memory, and input/output devices are interconnected by a number of point-to-point interfaces. The operations discussed with reference to FIGS. 1-5 can be performed by one or more components of the system 600.

As illustrated in FIG. 6, the system 600 includes several processors, of which only two, processors 602 and 604 are shown for clarity. The processors 602 and 604 each include a local Memory Controller Hub (MCH) 606 and 608 to enable communication with memories 610 and 612. The memories 610 and/or 612 store various data such as those discussed with reference to the memory 612 of FIG. 6. As shown in FIG. 6, the processors 602 and 604 (or other components of system 600 such as chipset 620, I/O devices 643, etc.) can also include one or more cache(s) such as those discussed with reference to FIGS. 1-5.

In an embodiment, the processors 602 and 604 are one of the processors 602 discussed with reference to FIG. 6. The processors 602 and 604 exchange data via a point-to-point (PtP) interface 614 using PtP interface circuits 616 and 618, respectively. Also, the processors 602 and 604 can each exchange data with a chipset 620 via individual PtP interfaces 622 and 624 using point-to-point interface circuits 626, 628, 630, and 632. The chipset 620 can further exchange data with a high-performance graphics circuit 634 via a high-performance graphics interface 636, e.g., using a PtP interface circuit 637.

In at least one embodiment, logic 150 is provided in one or more of the processors 602, 604 and/or chipset 620. Other embodiments, however, may exist in other circuits, logic units, or devices within the system 600 of FIG. 6. Furthermore, other embodiments may be distributed throughout several circuits, logic units, or devices illustrated in FIG. 6. For example, various components of the system 600 include the logic 150 of FIG. 1. However, logic 150 can be provided in locations throughout the system 600, including or excluding those illustrated.

The chipset 620 communicates with the bus 640 using a PtP interface circuit 641. The bus 640 has one or more devices that communicate with it, such as a bus bridge 642 and I/O devices 643. Via a bus 644, the bus bridge 642 communicates with other devices such as a keyboard/mouse 645, communication devices 646 (such as modems, network interface devices, or other communication devices that communicate with the computer network 605), audio I/O device, and/or a data storage device 648. The data storage device 648 stores code 649 that is executed by the processors 602 and/or 604.

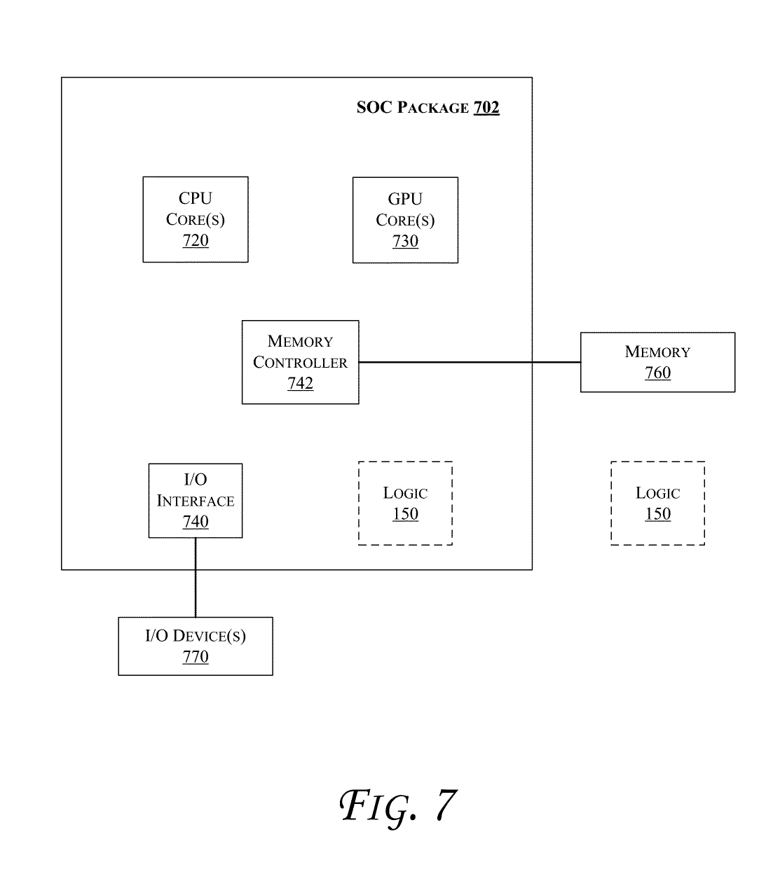

In some embodiments, one or more of the components discussed herein can be embodied as a System On Chip (SOC) device. FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 are coupled to an interconnect or bus such as discussed herein with reference to the other figures. Also, the SOC package 702 may include more or less components, such as those discussed herein with reference to the other figures. Further, each component of the SOC package 720 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 (which can be similar to or the same as memory discussed herein with reference to the other figures) via the memory controller 742. In an embodiment, the memory 760 (or a portion of it) can be integrated on the SOC package 702.

The I/O interface 740 is coupled to one or more I/O devices 770, e.g., via an interconnect and/or bus such as discussed herein with reference to other figures. I/O device(s) 770 include one or more of a keyboard, a mouse, a touchpad, a display, an image/video capture device (such as a camera or camcorder/video recorder), a touch screen, a speaker, or the like. Furthermore, SOC package 702 includes/integrates the logic 150 in an embodiment. Alternatively, the logic 150 is provided outside of the SOC package 702 (i.e., as a discrete logic).

The following examples pertain to further embodiments. Example 1 includes an apparatus comprising: first logic to receive a first message via a serial single ended bus; and the first logic to generate a second message to be transmitted to second logic in response to a determination that the first message is not directed to an address space assigned to the first logic, wherein the second message includes information from the first message. Example 2 includes the apparatus of example 1, wherein a detachable lid portion of a computing device is to comprise the first logic. Example 3 includes the apparatus of example 1, wherein a detachable based portion of a computing device is to comprise the second logic. Example 4 includes the apparatus of example 3, wherein the first logic is to be coupled to the second logic via the serial single ended bus. Example 5 includes the apparatus of example 1, wherein the second message is to include a copy of the first message. Example 6 includes the apparatus of example 1, wherein the first logic is to receive the first message from a device driver of an operating system. Example 7 includes the apparatus of example 6, wherein the first logic is to generate the second message without any changes to the device driver and the operating system. Example 8 includes the apparatus of example 1, wherein a detachable lid portion of a computing device is to comprise the first logic, a display device, a battery, and a processor having one or more processor cores. Example 9 includes the apparatus of example 1, wherein the first logic, a processor having one or more processor cores, and memory are to on a same integrated device. Example 10 includes the apparatus of example 1, wherein the second logic, a processor having one or more processor cores, and memory are to on a same integrated device. Example 11 includes the apparatus of example 1, wherein the serial single ended bus is to comprise an I2C (Interface to Communicate) bus.

Example 12 includes a method comprising: receiving a first message at a first logic via a serial single ended bus; and generating a second message to be transmitted to second logic in response to a determination that the first message is not directed to an address space assigned to the first logic, wherein the second message includes information from the first message. Example 13 includes the method of example 12, wherein the second message includes a copy of the first message. Example 14 includes the method of example 12, further comprising the first logic receiving the first message from a device driver of an operating system. Example 15 includes the method of example 14, further comprising the first logic generating the second message without any changes to the device driver and the operating system.

Example 16 includes a system comprising: a display device; a processor coupled to the display device to cause the display device to display one or more images stored in a memory; first logic, coupled to the memory, to receive a first message via a serial single ended bus; and the first logic to generate a second message to be transmitted to second logic in response to a determination that the first message is not directed to an address space assigned to the first logic, wherein the second message includes information from the first message. Example 17 includes the system of example 16, wherein a detachable lid portion of a computing device is to comprise the first logic. Example 18 includes the system of example 16, wherein a detachable based portion of a computing device is to comprise the second logic. Example 19 includes the system of example 18, wherein the first logic is to be coupled to the second logic via the serial single ended bus. Example 20 includes the system of example 16, wherein the second message is to include a copy of the first message. Example 21 includes the system of example 16, wherein the first logic is to receive the first message from a device driver of an operating system, wherein the memory is to store one or more of the device driver and the operating system. Example 22 includes the system of example 21, wherein the first logic is to generate the second message without any changes to the device driver and the operating system. Example 23 includes the system of example 16, wherein a detachable lid portion of a computing device is to comprise the first logic, the display device, a battery, and the processor having one or more processor cores. Example 24 includes the system of example 16, wherein the first logic, the processor having one or more processor cores, and the memory are to on a same integrated device. Example 25 includes the system of example 16, wherein the second logic, the processor having one or more processor cores, and the memory are to on a same integrated device.

Example 26 includes a computer-readable medium comprising one or more instructions that when executed on a processor configure the processor to perform one or more operations to: receive a first message at a first logic via a serial single ended bus; and generate a second message to be transmitted to second logic in response to a determination that the first message is not directed to an address space assigned to the first logic, wherein the second message includes information from the first message. Example 27 includes the computer-readable medium of example 26, wherein the second message includes a copy of the first message. Example 28 includes the computer-readable medium of example 26, further comprising one or more instructions that when executed on the processor configure the processor to perform one or more operations to cause the first logic to receive the first message from a device driver of an operating system. Example 29 includes the computer-readable medium of example 28, further comprising one or more instructions that when executed on the processor configure the processor to perform one or more operations to cause the first logic to generate the second message without any changes to the device driver and the operating system.

Example 30 includes an apparatus comprising means to perform a method as set forth in any preceding example.

Example 31 includes a machine-readable storage including machine-readable instructions, when executed, to implement a method or realize an apparatus as set forth in any preceding claim.

In various embodiments, the operations discussed herein, e.g., with reference to FIGS. 1-7, are implemented as hardware (e.g., circuitry), software, firmware, microcode, or combinations thereof, which can be provided as a computer program product, e.g., including a tangible (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-7. Additionally, such computer-readable media can be downloaded as a computer program product, wherein the program may be transferred from a remote computer (e.g., a server) to a requesting computer (e.g., a client) through data signals in a carrier wave or other propagation medium via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
first logic to receive a first message via a serial single ended bus; and
the first logic to generate a second message to be transmitted to second logic in response to a determination that the first message is not directed to an address space assigned to the first logic, wherein the second message includes information from the first message.

2. The apparatus of claim 1, wherein a detachable lid portion of a computing device is to comprise the first logic.

3. The apparatus of claim 1, wherein a detachable based portion of a computing device is to comprise the second logic.

4. The apparatus of claim 3, wherein the first logic is to be coupled to the second logic via the serial single ended bus.

5. The apparatus of claim 1, wherein the second message is to include a copy of the first message.

6. The apparatus of claim 1, wherein the first logic is to receive the first message from a device driver of an operating system.

7. The apparatus of claim 6, wherein the first logic is to generate the second message without any changes to the device driver and the operating system.

8. The apparatus of claim 1, wherein a detachable lid portion of a computing device is to comprise the first logic, a display device, a battery, and a processor having one or more processor cores.

9. The apparatus of claim 1, wherein the first logic, a processor having one or more processor cores, and memory are to on a same integrated device.

10. The apparatus of claim 1, wherein the second logic, a processor having one or more processor cores, and memory are to on a same integrated device.

11. The apparatus of claim 1, wherein the serial single ended bus is to comprise an I2C (Interface to Communicate) bus.

12. A method comprising:
receiving a first message at a first logic via a serial single ended bus; and
generating a second message to be transmitted to second logic in response to a determination that the first message is not directed to an address space assigned to the first logic, wherein the second message includes information from the first message.

13. The method of claim 12, wherein the second message includes a copy of the first message.

14. The method of claim 12, further comprising the first logic receiving the first message from a device driver of an operating system.

15. The method of claim 14, further comprising the first logic generating the second message without any changes to the device driver and the operating system.

16. A system comprising:
a display device;
a processor coupled to the display device to cause the display device to display one or more images stored in a memory;
first logic, coupled to the memory, to receive a first message via a serial single ended bus; and
the first logic to generate a second message to be transmitted to second logic in response to a determination that the first message is not directed to an address space assigned to the first logic, wherein the second message includes information from the first message.

17. The system of claim 16, wherein a detachable lid portion of a computing device is to comprise the first logic.

18. The system of claim 16, wherein a detachable based portion of a computing device is to comprise the second logic.

19. The system of claim 18, wherein the first logic is to be coupled to the second logic via the serial single ended bus.

20. The system of claim 16, wherein the second message is to include a copy of the first message.

21. The system of claim 16, wherein the first logic is to receive the first message from a device driver of an operating system, wherein the memory is to store one or more of the device driver and the operating system.

22. The system of claim 21, wherein the first logic is to generate the second message without any changes to the device driver and the operating system.

23. The system of claim 16, wherein a detachable lid portion of a computing device is to comprise the first logic, the display device, a battery, and the processor having one or more processor cores.

24. The system of claim 16, wherein the first logic, the processor having one or more processor cores, and the memory are to on a same integrated device.

25. The system of claim 16, wherein the second logic, the processor having one or more processor cores, and the memory are to on a same integrated device.
